(19) United States
(12) Patent Application Publication
(10) Pub. No.: US 2006/0120230 A1
(43) Pub. Date: Jun. 8, 2006

(54) Writing control method of optical recording/reproducing apparatus

(75) Inventors: Song-Ruei Chen, Hsinchu (TW); Rong-Son Jeng, Hsinchu (TW); Chien-Chang Wu, Hsinchu (TW); Yen-Chun Lin, Hsinchu (TW); Ren-Te Lin, Hsinchu (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Lite-On It Corp.

(21) Appl. No.: 11/294,240

(22) Filed: Dec. 5, 2005

(30) Foreign Application Priority Data
Dec. 7, 2004 (TW) 093137807

(51) Int. Cl. G11B 7/00; G11B 5/09

(52) U.S. Cl. 369/44.27; 369/47.1

(57) ABSTRACT

In a writing control method of an optical recording/reproducing apparatus, a data-writing operation is performed at a rotating speed. Meanwhile, an error signal is generated in response to a wobble signal. The error signal is periodically sampled. A counting value is obtained by accumulatively counting whenever the level of the error signal exceeds a threshold. The subsequent data-writing operation is performed at an increased rotating speed when the accumulatively counting value obtained within a preset period of time is no greater than a first preset value. The error signal can be a tracking error signal and/or a focusing error signal.

### FIELD OF THE INVENTION

The present invention relates to a control method of an optical recording/reproducing apparatus, and more particularly to a writing control method of an optical recording/reproducing apparatus.

### BACKGROUND OF THE INVENTION

A wobble signal is generated for the reference of an optical pickup head of an optical recording/reproducing apparatus to trace tracks and locate addresses when the optical recording/reproducing apparatus writes data into a recordable/rewritable optical disc (ex. DVD±R or DVD±RW). Taking a DVD+R disc shown in FIG. 1 as an example, a wobble signal with a wobble frequency of about 817.4 kHz is generated as a result of sinusoidal deviation from the ideal spiral of a groove 91 where a recording layer 910 is applied for data writing. If the dye distribution of the recordable/rewritable optical disc is not uniform, or the recordable/rewritable optical disc is subjected to distortion, scratch or dirt problems, the quality of the resulting wobble signal and thus the tracking and addressing operations of the optical pickup head would be adversely affected. This problem becomes even serious for high-speed writing, and it would likely result in the damage of the disc and/or the pickup head. Since the reliability of the written data highly correlates to the quality of the wobble signal, the wobble signal should be properly modified to avoid such problem.

### SUMMARY OF THE INVENTION

Therefore, the present invention provides a writing control method of an optical recording/reproducing apparatus, which properly controls the writing speed, thereby improving the data-writing quality.

The present invention relates to a writing control method of an optical recording/reproducing apparatus. In the method, a first data-writing operation is performed at a first rotating speed, and thus a first tracking error signal is generated. The first tracking error signal is periodically sampled and accumulatively counted whenever the level of the first tracking error signal exceeds a first threshold. Accordingly, a first counting value is obtained. The rotating speed is increased from the first rotating speed to a second rotating speed for a second data-writing operation on a first condition of the first counting value.

In an embodiment, the first condition is that the first counting value obtained within a first preset period of time is no greater than a first preset value. The first data-writing operation is retained at the first rotating speed when the first counting value obtained within the first preset period of time is greater than the first preset value.

For more than two rotating-speed stages, the writing control method performs the second data-writing operation at the second rotating speed. A second tracking error signal is generated in response to the second data-writing operation. The second tracking error signal is periodically sampled and accumulatively counted whenever the level of the second tracking error signal exceeds a second threshold. Accordingly, a second counting value is obtained. The rotating speed is increased from the second rotating speed to a third rotating speed for a third data-writing operation when the second counting value obtained within a second preset period of time is no greater than a second preset value. The second threshold is higher than the first threshold.

In an embodiment, the first data-writing operation is performed by referring to a wobble signal that is generated by reading wobbles from the optical disc.

In an embodiment, a focusing error signal is additionally generated in response to the first data-writing operation and periodically sampled. A third counting value is obtained by accumulatively counting whenever the level of the focusing error signal exceeds a third threshold. In this case, the first condition is that the first counting value obtained within a first preset period of time is no greater than a first preset value and the third counting value obtained within the first preset period of time is no greater than a third preset value. Alternatively, the first condition is that the sum of the first counting value and the third counting value obtained within a preset period of time is no greater than a fourth preset value.

The present invention also provides a writing control method of an optical recording/reproducing apparatus, comprising steps of performing a data-writing operation at a first rotating speed; generating a focusing error signal in response to the data-writing operation; periodically sampling the focusing error signal; accumulatively counting whenever the level of the focusing error signal exceeds a first threshold to obtain a first counting value; and increasing the rotating speed from the first rotating speed to a second rotating speed for the subsequent data-writing operation on a certain condition of the first counting value.

The present invention further provides a writing control method of an optical recording/reproducing apparatus, comprising steps of performing a data-writing operation at a rotating speed; generating an error signal in response to a wobble signal in the data-writing operation; periodically sampling the error signal; accumulatively counting whenever the level of the error signal exceeds a threshold; and performing the subsequent data-writing operation at an increased rotating speed when the accumulatively counting value obtained within a preset period of time is no greater than a first preset value.

The error signal can be a tracking error signal and/or a focusing error signal.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is schematic diagram showing a cut part of a DVD+R optical disc;

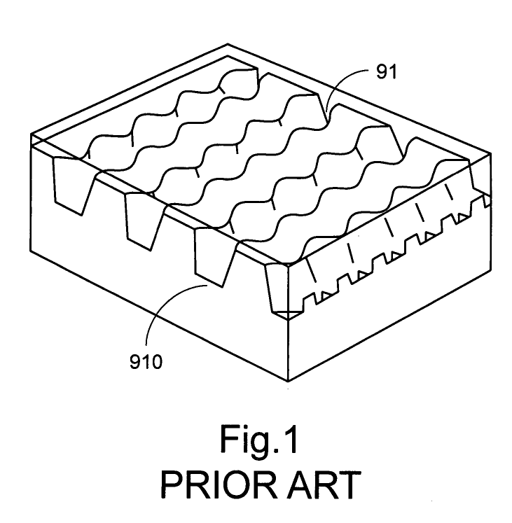

FIG. 2 is a functional block diagram for illustrating a writing control method according an embodiment of the present invention;

FIG. 3 is a plot exemplifying four rotating-speed stages of a writing control method according an embodiment of the present invention; and

FIG. 4 is a flowchart exemplifying a writing control method according an embodiment of the present invention.

### DETAILED DESCRIPTION OF THE PREFERRED EMBODIMENT

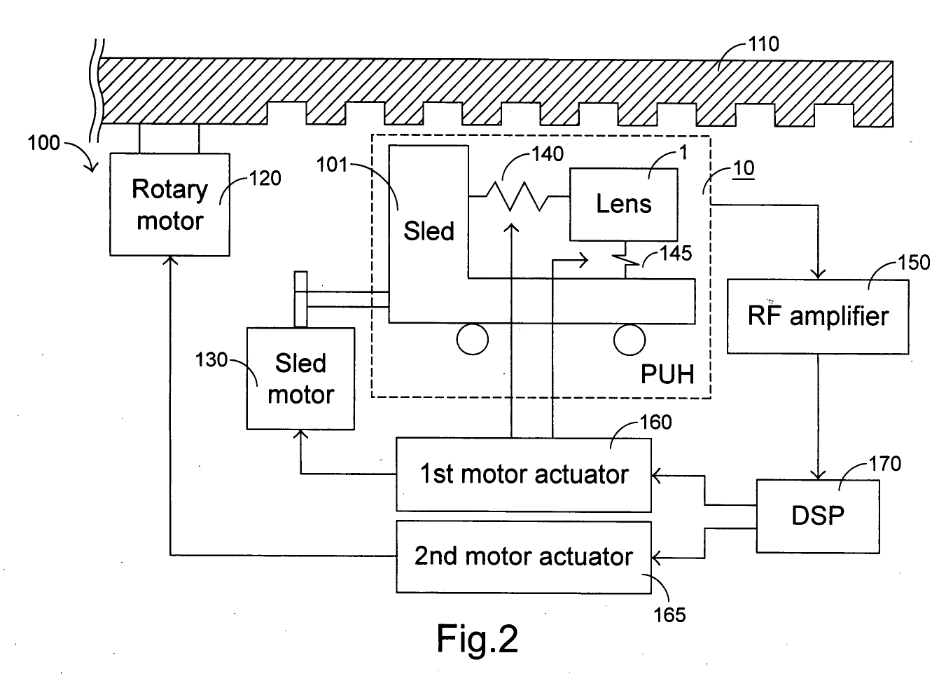

Please refer to FIG. 2. The optical recording/reproducing apparatus 100 includes an optical pickup head (PUH) 10 that is moved by a sled motor 130 and finely tuned with a tracking coil 140 in the tracking direction. In addition, the PUH 10 is moved in the focusing direction with a focusing coil 145. After the sled 101 of the PUH 10 is moved for a seeking operation by the sled motor 130, the lens 102 of the PUH is shifted with the tracking coil 140 and the focusing coil 145 for tracking and focusing operations.

For well tracking and addressing in a writing procedure, a feedback tracking mechanism is implemented. That is, the PUH 10 reads wobbles from the optical disc 110 so as to generate a wobble signal, and then a radio-frequency (RF) amplifier 150 generates a radio-frequency (RF) signal, a tracking error (TE) signal and a focusing error (FE) signal in response to the wobble signal. The RF, TE and FE signals are then inputted into and processed by a digital signal processor (DSP) 170 so as to result in a plurality of actuating signals. For example, the DSP 170 outputs three actuating signals to a first motor actuator 160 in response to the TE signal and the FE signal to control the movement of the sled motor 130, tracking coil 140 and focusing coil 145 so that the PUH 10 can precisely locate the target track and focus on the target point. An additional actuating signal is outputted to a second motor actuator 165 by the DSP 170 to control the rotary motor 120 so that the optical disc 110 can be rotated at a proper speed. According to the feedback tracking mechanism, the levels of the TE signal and the FE signal are supposed to be approximately zero. However, due to some unexpected problems like bad disc dyeing, disc distortion, scratch or dirt, the wobble signal may become unreliable and result in undesired drifts of TE and FE signals. Consequently, the actuating signals would be unable to move respective elements to proper positions.

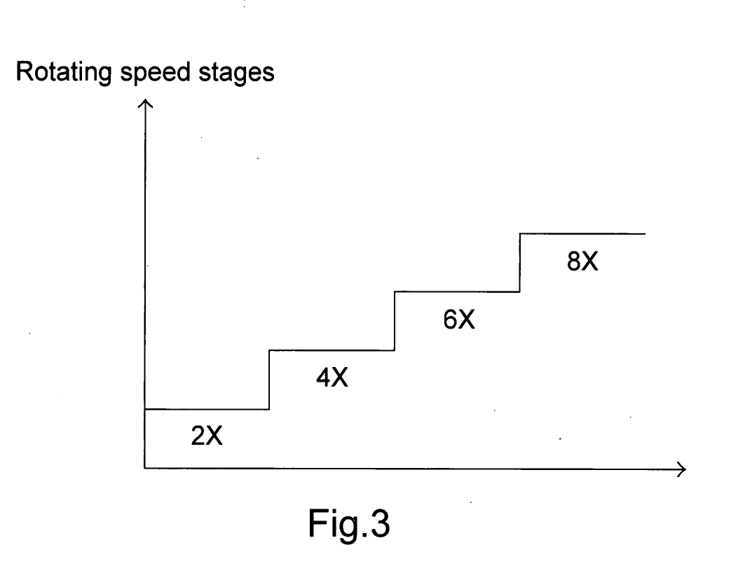

In order to solve these problems, the present invention monitors the TE and FE signals generated in response to the wobble signal in the feedback tracking writing procedure. According to the updated TE and FE signals, the rotating speed of the optical disc is properly adjusted. If the levels of the TE signal and/or FE signal change to a large extent within a preset period, the rotating speed of the optical disc has to keep at a low speed. On the other hand, if the levels of the TE signal and/or FE signal keep stable for a long term, the rotating speed of the optical disc can be increased. The increase in the rotating speed of the optical disc can be done in several stages, as shown in FIG. 3.

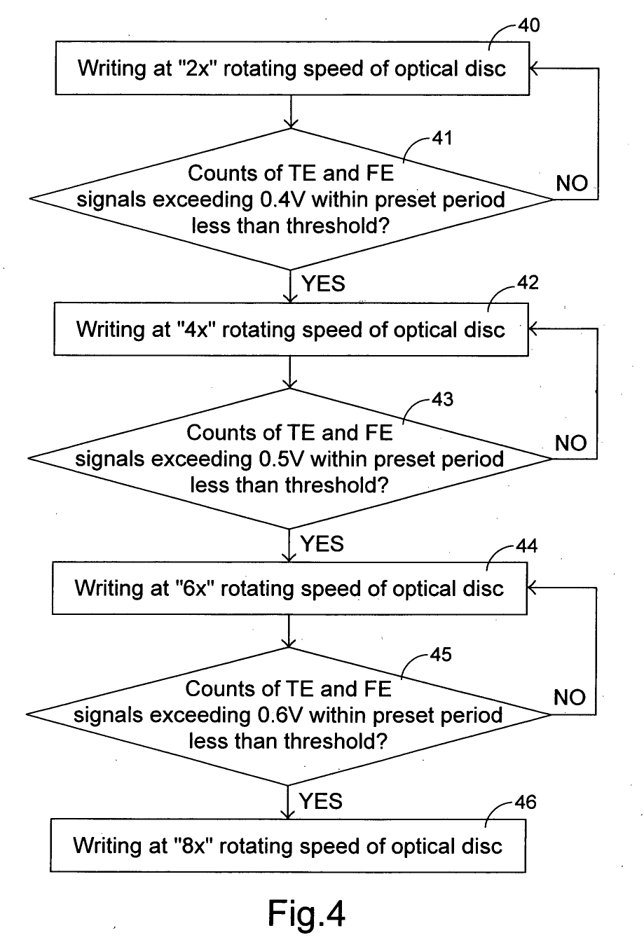

FIG. 4 is an exemplified flowchart of a speed control method of the present invention. The speed control method will be described hereinafter with reference to FIG. 3 as well. As exemplified by the stages of FIG. 3, there are four rotating speeds available for the optical recording/reproducing apparatus, e.g. 2×, 4×, 6× and 8×. In general but not necessarily, the optical recording/reproducing apparatus starts working at a minimal rotating speed, e.g. 2×. Meanwhile, the TE and FE signals are generated in a feedback mode and sampled periodically. For each rotating speed, respective threshold levels for determining whether the TE and FE signals are stable are preset for the TE signal and the FE signal. For example, on the condition that the optical disc is operated at a rotating speed of 2×, the threshold levels preset for the TE and FE signals are both 0.4 volts. If the counts of the TE and FE signals exceeding their threshold levels within preset periods of time are limited, i.e. less than preset numbers, the optical recording/reproducing apparatus can be considered operating well together with the PUH so that the rotating speed of optical disc can be increased to a higher level for example 4×. Otherwise, the rotating speed will keep at 2×. Then, the counts can be zeroed. On the condition that the optical disc is operated at a rotating speed of 4×, the threshold levels for the TE and FE signals are up-shifted to both 0.5 volts. The TE and FE signals exceeding their current-stage threshold levels are counted and compared with the preset count threshold in a similar way described above so as to determine whether the rotating speed should be increased or not. Likewise, the threshold levels 0.6 volts are used to discriminate the TE and FE signals when the optical disc is operated at a rotating speed of 6×.

As far as the comparison of the counts of the TE and FE signals exceeding their threshold levels within preset periods of time with the preset numbers is concerned, a variety of criteria can be applied. For example, the rotating speed of the optical disc can be increased as long as one of the signals TE and FE keep stable. That is, the count of the TE signal exceeding the TE threshold level is less than a corresponding preset number or the count of the FE signal exceeding the FE threshold level is less than another preset number corresponding thereto. Alternatively, the rotating speed of the optical disc cannot be increased unless the count of the TE signal exceeding the TE threshold level is less than a corresponding preset number and the count of the FE signal exceeding the FE threshold level is less than another corresponding preset number. In a further example, the count of the TE signal exceeding the TE threshold level and the count of the FE signal exceeding the FE threshold level are subjected to a mathematic operation so as to control the rotating speed of the optical disc. For example, the count of the TE signal exceeding the TE threshold level is added to the count of the FE signal exceeding the FE threshold level, and the rotating speed of the optical disc is increased when the sum is less than a preset number.

By using the present invention, the rotating speed of the optical disc in the writing procedure can be well controlled so as to result in more precise TE and FE signals in the feedback tracking mechanism. As a result, the reliability of the data written into the optical disc can be improved.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A writing control method of an optical recording/reproducing apparatus, comprising steps of:
performing a first data-writing operation at a first rotating speed;
generating a first tracking error signal in response to said first data-writing operation;
periodically sampling said first tracking error signal;
accumulatively counting whenever the level of said first tracking error signal exceeds a first threshold to obtain a first counting value; and
increasing the rotating speed from said first rotating speed to a second rotating speed for a second data-writing operation on a first condition of said first counting value.

2. The writing control method according to claim 1 wherein said first condition is that said first counting value obtained within a first preset period of time is no greater than a first preset value.

3. The writing control method according to claim 2 further comprising a step of retaining said first data-writing operation at said first rotating speed when said first counting value obtained within said first preset period of time is greater than said first preset value.

4. The writing control method according to claim 1 further comprising steps of:
performing said second data-writing operation at said second rotating speed;
generating a second tracking error signal in response to said second data-writing operation;
periodically sampling said second tracking error signal;
accumulatively counting whenever the level of said second tracking error signal exceeds a second threshold to obtain a second counting value; and
increasing the rotating speed from said second rotating speed to a third rotating speed for a third data-writing operation on a second condition of said second counting value,
wherein said second threshold is higher than said first threshold.

5. The writing control method according to claim 4 wherein said second condition is that said second counting value obtained within a second preset period of time is no greater than a second preset value.

6. The writing control method according to claim 5 further comprising a step of retaining said second data-writing operation at said first rotating speed when said second counting value obtained within a second preset period of time is greater than said first preset value.

7. The writing control method according to claim 1 wherein said first data-writing operation is performed by referring to a wobble signal that is generated by reading wobbles from the optical disc.

8. The writing control method according to claim 1 further comprising steps of:
generating a focusing error signal in response to said first data-writing operation;
periodically sampling said focusing error signal; and
accumulatively counting whenever the level of said focusing error signal exceeds a third threshold to obtain a third counting value.

9. The writing control method according to claim 8 wherein said first condition is that said first counting value obtained within a first preset period of time is no greater than a first preset value and said third counting value obtained within said first preset period of time is no greater than a third preset value.

10. The writing control method according to claim 8 wherein said first condition is that the sum of said first counting value and said third counting value obtained within a preset period of time is no greater than a fourth preset value.

11. A writing control method of an optical recording/reproducing apparatus, comprising steps of:
performing a data-writing operation at a first rotating speed;
generating a focusing error signal in response to said data-writing operation;
periodically sampling said focusing error signal;
accumulatively counting whenever the level of said focusing error signal exceeds a first threshold to obtain a first counting value; and
increasing the rotating speed from said first rotating speed to a second rotating speed for the subsequent data-writing operation on a certain condition of said first counting value.

12. The writing control method according to claim 11 wherein said certain condition is that said first counting value obtained within a preset period of time is no greater than a first preset value.

13. The writing control method according to claim 12 further comprising a step of retaining said data-writing operation at said first rotating speed when said first counting value obtained within said preset period of time is greater than said first preset value.

14. The writing control method according to claim 11 wherein said data-writing operation is performed by referring to a wobble signal that is generated by reading wobbles from the optical disc.

15. The writing control method according to claim 11 further comprising steps of:
generating a tracking error signal in response to said data-writing operation;
periodically sampling said tracking error signal; and
accumulatively counting whenever the level of said tracking error signal exceeds a second threshold to obtain a second counting value.

16. The writing control method according to claim 15 wherein said certain condition is that said first counting value obtained within a preset period of time is no greater than a first preset value and said second counting value obtained within said preset period of time is no greater than a second preset value.

17. The writing control method according to claim 15 wherein said certain condition is that the sum of said first counting value and said second counting value obtained within a preset period of time is no greater than a third preset value.

18. A writing control method of an optical recording/reproducing apparatus, comprising steps of:
performing a data-writing operation at a rotating speed;
generating an error signal in response to a wobble signal in said data-writing operation;
periodically sampling said error signal;
accumulatively counting whenever the level of said error signal exceeds a threshold; and
performing the subsequent data-writing operation at an increased rotating speed when the accumulatively counting value obtained within a preset period of time is no greater than a first preset value.

19. The writing control method according to claim 18 wherein said error signal is a tracking error signal or a focusing error signal.

20. The writing control method according to claim 18 wherein said error signal includes a tracking error signal and a focusing error signal.
